(19) United States
(12) Patent Application Publication
(10) Pub. No.: US 2020/0027103 A1
(43) Pub. Date: Jan. 23, 2020

(54) Prioritization System for Products Using a Historical Purchase Sequence and Customer Features

(71) Applicant: Adobe Inc., San Jose, CA (US)

(72) Inventors: Jin Xu, San Jose, CA (US); Zhenyu Yan, Cupertino, CA (US); Wenqing Yang, Santa Clara, CA (US); Tianyu Wang, San Jose, CA (US); Abhishek Pani, San Francisco, CA (US)

(73) Assignee: Adobe Inc., San Jose, CA (US)

(21) Appl. No.: 16/042,882

(22) Filed: Jul. 23, 2018

(51) Int. Cl. G06Q 30/02; G06Q 10/06; G06N 7/00

(52) U.S. Cl. CPC G06Q 30/0202; G06N 99/005; G06N 7/005; G06Q 10/067

(57) ABSTRACT

Prioritization techniques and systems are described that utilize a historical purchase sequence and customer features to prioritize products and services to generate product and service recommendations. In an example, feature data describing a customer and historical purchase data for the customer is received that indicates products or services purchased by the customer. The historical purchase data further includes indicators of when the products or services were purchased by the customer. Then, probabilities of future purchases by the customer of additional products are determined by classifying the additional products using a multiclass classification. The multiclass classification is based on the historical purchase data and the feature data describing the customer. Next, a ranking of the additional products is generated based on the determined probabilities of future purchases. The ranking of the additional products is output in a user interface based on the determined probabilities.

### BACKGROUND

Product recommendation systems implemented by computing devices aim to give suggestions to users working in sales and marketing as to which products and services to target to particular customers. Product recommendation systems also aim to reduce the guesswork often associated with determining which products and services particular customers are most likely to purchase in order to improve efficiency in sales and marketing efforts. Because sales and marketing resources for any provider of products and services are limited, however, resource allocation techniques are employed by the product recommendation systems to prioritize products and services that customers are most likely to purchase and allocate resources accordingly.

Conventional product recommendation computing systems present challenges by not accounting for sufficient circumstances related to customers when evaluating which products and services to target to those customers. These conventional product recommendation systems further do not take into account different products that are available for the customers to purchase, e.g., products from other retailers, or similar products from a same retailer. Therefore, conventional product recommendation systems present product recommendations that are not suited to the circumstances of a particular customer, and cause sales and marketing teams to inefficiently allocate time and money to different accounts.

In particular, there are two commonly used conventional product recommendation techniques which present these challenges. A first conventional product recommendation technique prioritizes products and services in a “one-versus-all” approach, in which separate propensity models are built for different products available to be targeted to a customer. The propensity models are then used to determine a product with the largest propensity, i.e., likelihood to result in conversion. However, this “one-versus-all” technique is limited to comparison of customers with respect to a particular product. As a result, this conventional technique cannot compare different products for a specific customer.

A second conventional product recommendation technique analyzes purchase sequences of customers, and from this, determines a specific purchase sequence with the highest frequency to suggest products to include in a product recommendation. Conventional product recommendation systems that analyze purchase sequences, however, cannot distinguish between customers based on firmographic or third-party features. As a result, these conventional product recommendation systems give identical prediction results as long as customers share a same purchase history, leading to inaccurate purchase predictions.

Consequently, conventional product recommendation systems give incomplete information when targeting products and services to customers, leading to wasted resource allocation by sales and marketing systems. Additionally, these conventional product recommendation systems result in inefficient use of computing resources and thus operation of a computing device that implements these conventional systems, as the inputs to these systems are often superfluous, using data that does not assist in an accurate targeting prediction.

### SUMMARY

Prioritization techniques and systems are described to generate product and service recommendations by leveraging a historical purchase sequence and customer features to prioritize products and services to be targeted to customers. Customer features are characteristics and qualities of a customer itself, or a third-party customer, and can often be found in firmographic data. Firmographic data describes characteristics and qualities of the customer with descriptive attributes of the customer for use in aggregating individual customers into market segments. In one example, data is received that includes feature data describing characteristics and qualities of a customer, along with historical purchase data for the customer that indicates products or services purchased by the customer. The historical purchase data further includes indicators of a time, at which, the products or services are purchased by the customer. Probabilities of future purchases by the customer of additional products are generated by the system based on a multiclass classification that classifies the additional products into groups corresponding to the products or services already purchased by the customer. The multiclass classification is based on the historical purchase data and the feature data describing the customer. The system ranks the additional products based on the determined probabilities, such as by ranking the additional products that the customer is most likely to purchase highest.

The ranking of the additional products is output in a user interface based on the determined probabilities, thus displaying a limited set of information to a user in a specific manner. For instance, the ranking of the additional products summarizes a significant amount of information regarding the features of the customer and the historical purchase data for the customer in a particular manner, such as a numbered list, that is easy for users to comprehend. Furthermore, the ranking of the additional products provides a limited set of data in the user interface, such as by omitting products that do not meet certain thresholds from consideration in the ranking Thus, the techniques described herein overcome the limitations of conventional systems that utilize “one-versus-all” methods and/or determining a specific purchase sequence, which each employ a significant cost in operational performance of a computing device.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ product prioritization system techniques described herein.

FIG. 2 depicts a system in an example implementation showing operation of the product prioritization system of FIG. 1 in greater detail.

FIG. 3 depicts a system in an example implementation of using the product prioritization techniques described herein to generate recommendations in scenarios involving customers having different characteristics which may be included in feature data.

FIG. 4 depicts a validation plot for the product prioritization techniques and systems described herein using time-constrained validation.

FIG. 5 depicts a validation plot for the product prioritization techniques and systems described herein comparing number of products included in a product group to actual number of products purchased.

FIG. 6 depicts a validation plot for the product prioritization techniques and systems described herein indicating inclusion accuracy of number of products included in a product group.

FIG. 7 is a flow diagram depicting a procedure in an example implementation in which products prioritized using a historical purchase sequence are output in a user interface by a product prioritization system.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

Overview

Conventional product recommendation systems that provide product recommendations to sales and marketing teams for targeting customers typically rely upon “one-versus-all” techniques and/or a determination of a specific purchase sequence that is exactly replicated to analyze different customers. The “one-versus-all” approach is often implemented as part of a “next-product-to-buy” (NPTB) technique. Challenges arise with the use of the “one-versus-all” approach utilized by conventional product recommendation systems because the “one-versus-all” approach is limited to a customer comparison given a particular product. The “one-versus-all” technique is especially vulnerable when a large provider of a product or service takes over a market area due to its scale, rather than relevance of a particular product or service. In other words, when a conventional product recommendation system utilizes the “one-versus-all” technique in a scenario with a large product provider, the product recommendation system is required to simply compare customers who have purchased the same product, from the same large product provider, thus generating meaningless product recommendations.

The NPTB problem is also solved by conventional product recommendation systems based on purchase sequence, alone. Specifically, this strategy involves locating a specific purchase sequence having the highest frequency, but has inherent challenges, as identical prediction results are presented as long as customers share a same purchase history. Limiting evaluation to the purchase sequence of customers does not account for other factors associated with the customers or the products which may affect future purchases, such as firmographic or third-party features. In an example, a conventional product recommendation system utilizing purchase sequence alone generates identical product recommendations of a large, expensive product for two customers that have each purchased two small products, not taking into consideration that one of the customers may not have the revenue to purchase the large expensive product while the other customer does have sufficient revenue.

Accordingly, techniques are described in which a computing device prioritizes products or services using a historical purchase sequence along with features of customers. The challenges described above in relation to conventional product recommendation systems are overcome by incorporating circumstances of different customers to generate data-driven product recommendations that can be used by sales and marketing teams to efficiently allocate team members to different customer accounts. Customer features utilized by the product prioritization systems described herein are characteristics and qualities of a customer itself. Customer features may be found in firmographic data, which includes descriptive attributes of retailers and can be used to aggregate individual retailers into market segments. Examples of attributes included in the feature data may be number of employees, revenue, industry, location, customer size, status and/or structure, performance, and so forth.

First, the computing device receives feature data describing a customer, such as firmographic data associated with the customer. The feature data may also include information on third-party customers, such as firmographic data of third-party customers that correspond to relevant features of the customer being analyzed. The feature data provides the computing device with information on circumstances relating to the customer, and/or third-party customers, which can be leveraged to provide product recommendations tailored to the particular customer. The computing device also receives historical purchase data for the customer that specifies products or services previously purchased by the customer, and indicators of when the products were purchased by the customer. The computing device is configured to identify, from the historical purchase data, the products previously purchased by the customer and when the products were purchased by the customer.

Next, the computing device determines probabilities of future purchases by the customer involving additional products. To do so, the computing device classifies the additional products using a multiclass classification based on the historical purchase data and the feature data describing the customer. The multiclass classification classifies the additional products into groups corresponding to the products that the customer previously purchased. In one example, the additional products are classified using an n-class classification problem, which is solved using a random forest model. The computing device outputs a ranking of the additional products based on the determined probabilities of future purchases in a user interface, which may be used as a basis for selection of digital content (e.g., digital marketing content) for output to a user. The ranking of the additional products provides users with reliable predictions of which customers will purchase particular products by utilizing features of the customers as part of the predictions. The ranking of the additional products is more reliable than conventional techniques that relied on purchase histories alone, or are limited to a single product for comparisons, as these conventional techniques did not utilize data corresponding to the particular circumstances surrounding an individual customer.

As part of output of the additional products, the computing device may further refine the ranking of the additional products by comparing the determined probabilities to a threshold probability for inclusion in a product group. For instance, the computing device may include products, solely, in the ranking that have a probability of purchasing the product that is higher than a quantile of average probability, such as ninety-eight percent likelihood that the customer will purchase a product. If a particular customer an average propensity higher than ninety-eight percent probability, then in this example three products are included in the ranking.

In this way, the techniques and systems described herein can easily and quantitatively identify products and services to target to customers that have a high probability of being purchased, without the uncertainty present in conventional product recommendation systems that did not account for features of customers along with historical purchase sequence. Specifically, utilizing the circumstances of a particular customer to generate product recommendations in a data-driven manner overcomes the challenges presented by conventional product recommendation systems which provided incomplete and inaccurate product recommendations, leading to misallocation of resources and products targeted to customers unsuitably. The rankings of products described herein are output in a specific manner in a user interface of a computing device and represent a limited set of information that is specific to the customer being evaluated and products or services that apply in the circumstances of the particular customer. The techniques described herein improve accuracy in generating quantitative rankings of products or services to target to customers by accounting for features that may affect the customer's decision to purchase one or more products, thus improving the operational efficiency of a computing device that employs these techniques.

In the following discussion, an example environment is first described that may employ the techniques described herein. Example procedures are also described which may be performed in the example environment as well as other environments.

Consequently, performance of the example procedures is not limited to the example environment and the example environment is not limited to performance of the example procedures.

### Term Examples

“Digital products and services” refers to products or tools that can generally be created once and then sold or otherwise provided to multiple customers many times. Digital products and services can be delivered digitally to customers, such as over a network. Digital products and services may be configured to allow access to multiple users through a single license to use the digital products and services, such as in a workplace having multiple employees. Digital products and services may include digital content, which includes any type of data that is configured to be rendered for output by an output device of a computing device to a user. Examples of digital content include digital images, digital audio, digital media, digital video, digital articles, digital text, and so forth.

“Multiclass classification” is a problem of classifying instances into one of three or more classes, as opposed to “binary classification” which classifies instances into two classes. Multiclass classification encompasses n-class classification, in which there are n classes into which instances are classified. Algorithms which can be used to address multiclass classification include neural networks, decision trees, k-nearest neighbors, naïve Bayes, support vector machines, and extreme learning machines.

“Random forest model” is an ensemble learning method for classification, regression, or other tasks that operates by constructing a multitude of decision trees at training time and outputting the class that is the mode of input classes, or a mean prediction of the individual trees.

“Propensity model” is a statistical representation used to predict behavior of customers or other prospects. Propensity models are often used to identify those most likely to respond to respond to an offer or to focus retention activity on those most likely to churn, to name a few examples.

“Customer” may refer to a potential customer or existing customer. A potential customer is any entity that is not yet a recipient of digital products and/or services marketed by a provider. An existing customer is any entity that is already receiving one or more digital products and/or services from a provider. Potential and existing customers may range from a single individual user to a customer enterprise having dozens or hundreds of individual users.

Example Environment

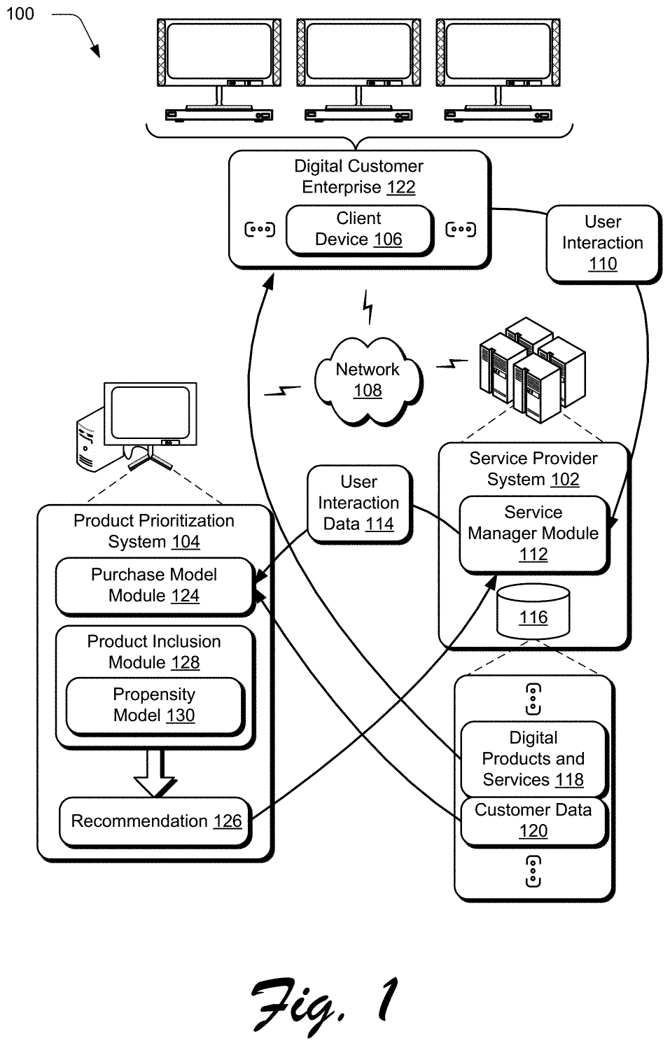

FIG. 1 is an illustration of a digital medium environment 100 in an example implementation that is operable to employ techniques for prioritizing products using a historical purchase sequence and customer features as described herein. The illustrated environment 100 includes a service provider system 102, a product prioritization system 104, and a plurality of client devices, an example of which is illustrated as client device 106. These devices are communicatively coupled, one to another, via a network 108 and may be implemented by a computing device that may assume a wide variety of configurations.

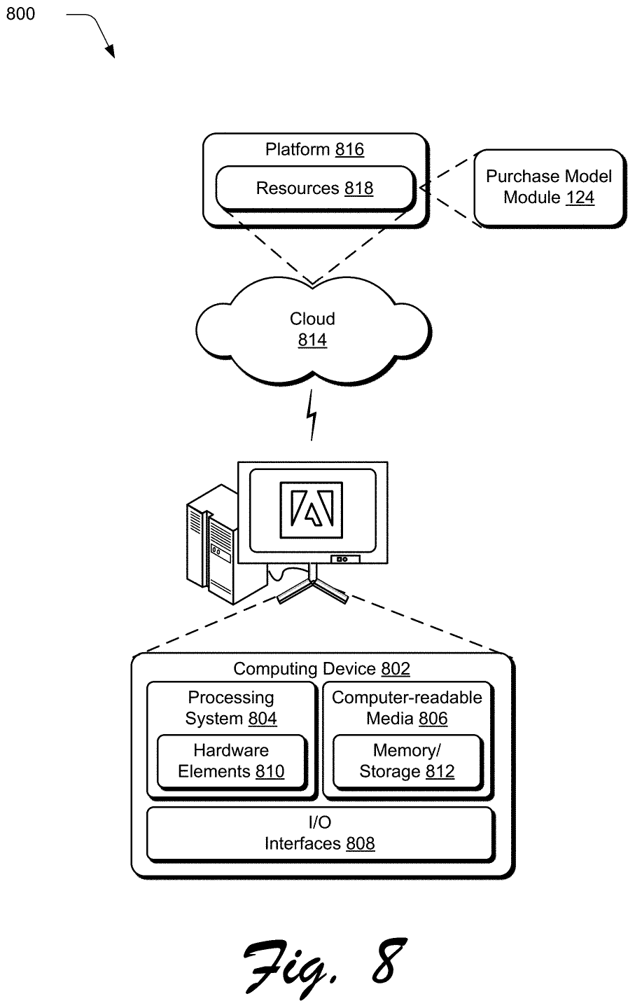

A computing device, for instance, may be configured as a desktop computer, a laptop computer, a mobile device (e.g., assuming a handheld configuration such as a tablet or mobile phone), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is shown, a computing device may be representative of a plurality of different devices, such as multiple servers utilized by a business to perform operations “over the cloud” as shown for the service provider system 102 and the product prioritization system 104 and as further described in FIG. 8.

The client device 106 is illustrated as engaging in user interaction 110 with a service manager module 112 of the service provider system 102. The service provider system 102, for instance, may be configured to support user interaction with digital products and services 118. User interaction data 114 is then generated (e.g., by the service manager module 112) that describes this user interaction 110, which may be stored in a storage device 116 along with the digital products and services 118 themselves. The user interaction data 110 may further be used by the service manager module 112 to generate customer data 120 indicating features of customers who either have purchased, or may potentially purchase, the digital products and services 118. The customer data 120 may additionally include firmographic data of third-party customers to be used in comparisons of features of a customer being analyzed for targeting the digital products and services 118. As described above, firmographic data describes characteristics and qualities of the customer and includes descriptive attributes of the customer for use in aggregating individual customers into market segments.

The digital products and services 118 may take a variety of forms and thus user interaction 110 with the digital products and services 118 may also take a variety of forms. For example, the client device 106 may be part of a digital customer enterprise 122 that maintains a subscription to one or more of the digital products and services 118. Once subscribed to the digital products and services 118, the digital customer enterprise 122 allows the computing device 106 to interact with the digital products and services such as digital content and functionalities associated with the digital products and services. Digital content included with the digital products and services 118 may take a variety of forms, such as electronic messages, email, banner ads, posts, and so forth. One specific example of digital products and services 118 are those digital products included in the Adobe® Marketing Cloud, such as Adobe® Advertising Cloud, Adobe® Analytics, Adobe® Primetime, Adobe® Target, and so forth, which may be provided to individual computing devices 106 through the digital customer enterprise 122. In another example, the client device 106 may obtain access to the digital products and services 118 individually without the digital customer enterprise 122.

The user interaction data 114 is received by a purchase model module 124 of the product prioritization system 104, which employs this data to provide a recommendation 126 for targeting the digital products and services 118 to the digital customer enterprise 122 and/or the computing device 106. The purchase model module 124 is configured to rank the digital products and services 118 according to how likely a customer is to purchase the digital products and services, where the ranking is based on a historical purchase sequence of the customer along with features of the customer. The digital products and services 118 may then be marketed to potential and/or existing customers, such as the digital customer enterprise 122, based on the recommendation 126. For instance, once purchased by the digital customer enterprise 122, the digital products and services 118 are output to the computing device 106 of the digital customer enterprise directly via the network 108 or indirectly via the service provider system 102 by the service manager module 112.

The product prioritization system 104 may also include a product inclusion module 128 configured to utilize the product ranking output by the purchase model module 124 and exclude certain products and/or services from the recommendation 126. To do so, the product inclusion module 128 employs a propensity model 130, which determines a probability of a customer purchasing products and/or services. The product inclusion module 128, for instance, may then compare the probability determined using the propensity model 130 to threshold values for inclusion in the recommendation 126. In another example, the product inclusion module 128 may limit a total number of products or services to be marketed to a customer in the recommendation 126, despite the probability of the customer purchasing the respective products or services. This refined ranking may then be used for the recommendation 126, and output to the service manager module 112 for marketing the digital products and services 118 as described above. By excluding certain products and services from the recommendation 126, sales and marketing teams can appropriately allocate resources to those products and services that are most likely to be sold to individual customers.

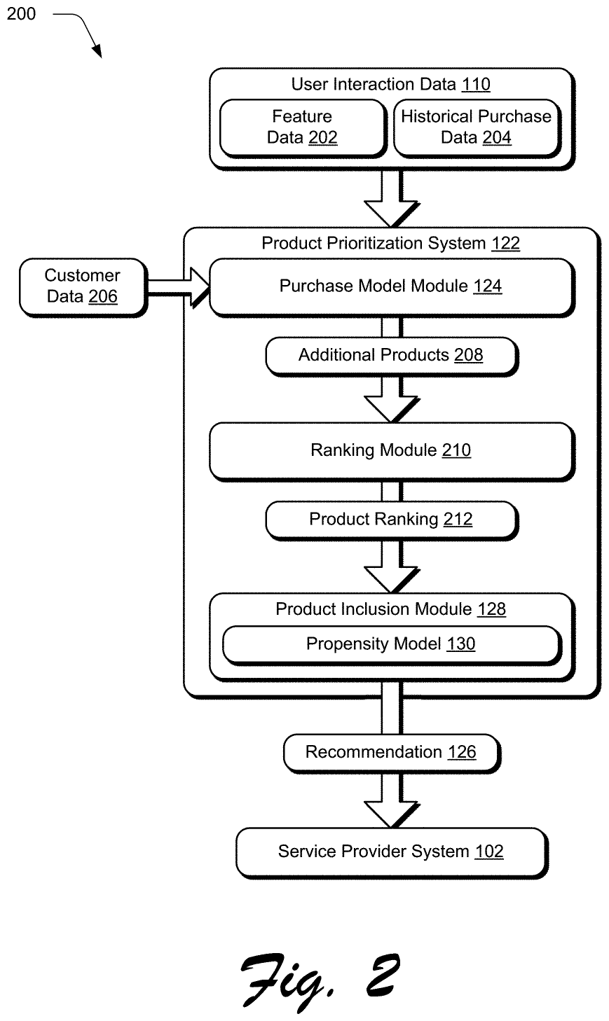

Turning now to FIG. 2, a system 200 is depicted showing operation of the product prioritization system 122 of FIG. 1 in greater detail. In this example, the purchase model module 124 receives the user interaction data 110, which includes feature data 202 and historical purchase data 204 for a particular customer. The feature data 202 may be, for example, firmographic data that describes characteristics and qualities of the customer and includes descriptive attributes of the customer for use in aggregating individual customers into market segments. Examples of attributes included in the feature data 202 may be number of employees, revenue, industry, location, customer size, status and/or structure (e.g., independent business, part of a larger parent company, headquarters of a parent company, stand-alone entity, franchisee of franchising organization, subsidiary of a larger organization, sole proprietorship, limited liability corporation, private corporation, public shareholder-owned corporation, etc.), performance (e.g., business execution over time, duration of existence, rate of growth or decline, profits and losses, changes in profits and losses, etc.) and so forth.

The historical purchase data 204 indicates products and/or services that the customer previously purchased and when the respective products and/or services were purchased. In one example, the historical purchase data 204 may include indications of products or services purchased in specific timeframe increments, such as weeks, months, quarter-years, years, and so on. The purchase model module 124 identifies the products and/or services that the customer previously purchased from the historical purchase data 204, and further identifies when the respective products and/or services were purchased from the historical purchase data.

The purchase model module 124 then determines probabilities of future purchases by the customer of additional products 208 using the feature data 202 and the historical purchase data 204. The additional products 208 may include products that the customer has not yet purchased, and/or may include products that the customer has already purchased but could purchase again. The purchase model module 124 determines the probabilities based on a multiclass classification using the historical purchase data 204 and the feature data 202 describing the customer. The multiclass classification classifies the additional products 208 into groups corresponding to the products previously purchased by the customer. The purchase model module 124 may also use customer data 206 to compare the customer being analyzed to additional customers in determining the probabilities of future purchases of the additional products 208. Similar to the feature data 202, the customer data 206 includes firmographic data that describes characteristics and qualities of additional customers and includes descriptive attributes of the additional customers for use in aggregating individual customers into market segments. The customer data 206 may include characteristics and qualities of the additional customers that correspond to the characteristics and qualities of the customer being analyzed, or may include different characteristics and qualities.

For instance, consider a customer that purchases m products in one year. In this example, the purchase model module 124 generates m samples for the customer for that specific year, and each of the m samples serves as a response variable for the respective samples. Purchases before the specific year are then considered “historical” purchases, which can be included in the historical purchase data 204. If there are n products offered in total, n indicator variables are generated denoting whether the customer has purchased a given product as a historical purchase. In this scenario, the indicator variable takes a value of 1 if it is a historical purchase; otherwise, the indicator variable takes a value of 0.

The purchase model module 124 incorporates the n indicator variables along with the feature data 202 and the customer data 206 into the multiclass classification problem, which may be solved using a random forest model. The multiclass classification problem may be, for instance, an n-class classification problem in which the n products correspond to the number of possible classifications, or groups corresponding to the products previously purchased by the customer. The random forest model constructs a multitude of decision trees corresponding to the different classes in the multiclass classification problem, and can output a mode of the classes (classification) or mean prediction (regression) of the individual decision trees, for instance.

In a specific example, assume a customer assigned an identification number of 001 has the following purchase history:

TABLE 1

| | Year | | | | | |
|---|---|---|---|---|---|---|
| | 2012 | 2013 | 2014 | 2015 | 2016 | 2017 |
| Products | Analytics | — | AEM_Forms | Social, | — | Target |
| | | | | Prime- | | |
| | | | | time | | |

This customer purchased Analytics in 2012, AEM_Forms in 2014, Social and Primetime in 2015, and Target in 2017. This customer did not make any purchases in 2013 and 2016. Because this customer has five total product purchases, there are five samples, where one product purchase corresponds to one sample. The following table provides these samples and features from the customer's purchase history indicating whether the customer has purchased specific products:

TABLE 2

| | | | x_{product} | | | | | | | x_{ECP} |
|---|---|---|---|---|---|---|---|---|---|---|
| Year | ID | y | x_{Analytics} | x_{Primetime} | x_{Social} | x_{Target} | . . . | x_{AEM}_{_{—}}_{Forms} | age | . . . |
| 2012 | 001 | Analytics | 0 | 0 | 0 | 0 | . . . | 0 | 1 | . . . |
| 2014 | 001 | AEM_Forms | 1 | 0 | 0 | 0 | . . . | 0 | 3 | . . . |
| 2015 | 001 | Social | 1 | 0 | 0 | 0 | . . . | 1 | 4 | . . . |
| 2015 | 001 | Primetime | 1 | 0 | 0 | 0 | . . . | 1 | 4 | . . . |
| 2016 | 001 | Target | 1 | 1 | 1 | 1 | . . . | 1 | 5 | . . . |
| . . . | . . . | . . . | . . . | . . . | . . . | . . . | . . . | . . . | . . . | . . . |

The indicator variables x_{Analytics}, x_{Analytics}, x_{Analytics}, etc. represent specific products in a product suite, for instance. In this example, each product in x_{product} corresponds to a sample, and thus each product has a corresponding indicator variable that indicates whether the respective products are historical purchases for the customer. By solving a multiclass classification problem, such as an n-class classification problem where each product is used for a classification, the purchase model module 124 obtains a probability distribution among the different products. In this example, the probability of previous purchased products is set to zero, and the purchase model module 124 determines probabilities for the remaining products (e.g., the products that were not previously purchased). However, examples are also considered in which previously purchased products are used in determining probabilities of products to be purchased by a customer.

Next, a ranking module 210 receives the additional products 208 and generates a product ranking 212 of the additional products based on the determined probabilities of the future purchases. The ranking module 210, for instance, may rank the additional products 208 from the most likely to be purchased by the customer to the least likely to be purchased, with the product having the highest probability of future purchase being the most likely to be purchased. The product ranking 212 that includes a ranking of each product, in some cases, may be directly output as the recommendation 126 such that sales and marketing teams can make resource allocations accordingly.

However, in other instances, it may be beneficial to exclude some of the additional products 208 from the recommendation 126. Many sales and marketing teams may not have the resources to target every available product to a customer with the attention that the respective products need in order to be sold. Furthermore, some customers have little to no use for certain products or services, and it would therefore be fruitless to allocate resources to sales and marketing of these products to the particular customer.

Accordingly, the product inclusion module 128 determines which products of the additional products 208 should be included in the recommendation 126. To do so, the product inclusion module 128 generates a propensity model 130 to determine a probability of a specific customer to purchase each of the additional products 208. Continuing with the example above, if there are n total products, the product inclusion module 128 generates n propensity models 130 and therefore n probabilities for each customer. In some cases, it can be assumed that the customer has not yet purchased any products or may repeat purchases, so all of the n products can be used to generate the propensity models 130. In other cases, the number of products can be reduced to only those products not yet purchased by the customer to generate the propensity models 130, as appropriate based on the customer and products being evaluated.

The product inclusion module 128 calculates an average of the probabilities of the customer purchasing the respective products determined using the propensity models 130. The average of the probabilities is used to divide the probabilities into quantiles, with generally half of the additional products 208 having the highest probabilities being in a first group and half of the additional products having the lower probabilities being in a second group. The product inclusion module 128 can use the average of the probabilities to compare to threshold values to determine how many products to include in the recommendation 126. For example, for customers having an average probability of 98%, the top three products may be included in the recommendation 126, where the top three products are the products with the highest determined probabilities of being purchased. In the same example, customers having an average probability of 92% may only include one product in the recommendation 126. The following table depicts three different customers having different determined average probabilities, and therefore different numbers of products to be included in a recommendation:

| | | | | | Inclusion | Inclusion | Inclusion |
|---|---|---|---|---|---|---|---|
| Customer | Rank of | Rank of | Rank of | Inclusion | label of | label of | label of |
| id | product 1 | product 2 | product 3 | count | product 1 | product 2 | product 3 |
| 1001 | 3 | 1 | 2 | 3 | YES | YES | YES |
| 1002 | 1 | 2 | 3 | 1 | YES | NO | NO |
| 1003 | 1 | 3 | 2 | 2 | YES | NO | YES |

The product inclusion module 130 outputs the recommendation 126 to the service provider system 102, which can utilize the recommendation in a variety of ways. For example, the recommendation 126 may output in a user interface for use by sales and marketing teams to allocate resources effectively when determining which products to target to different customers.

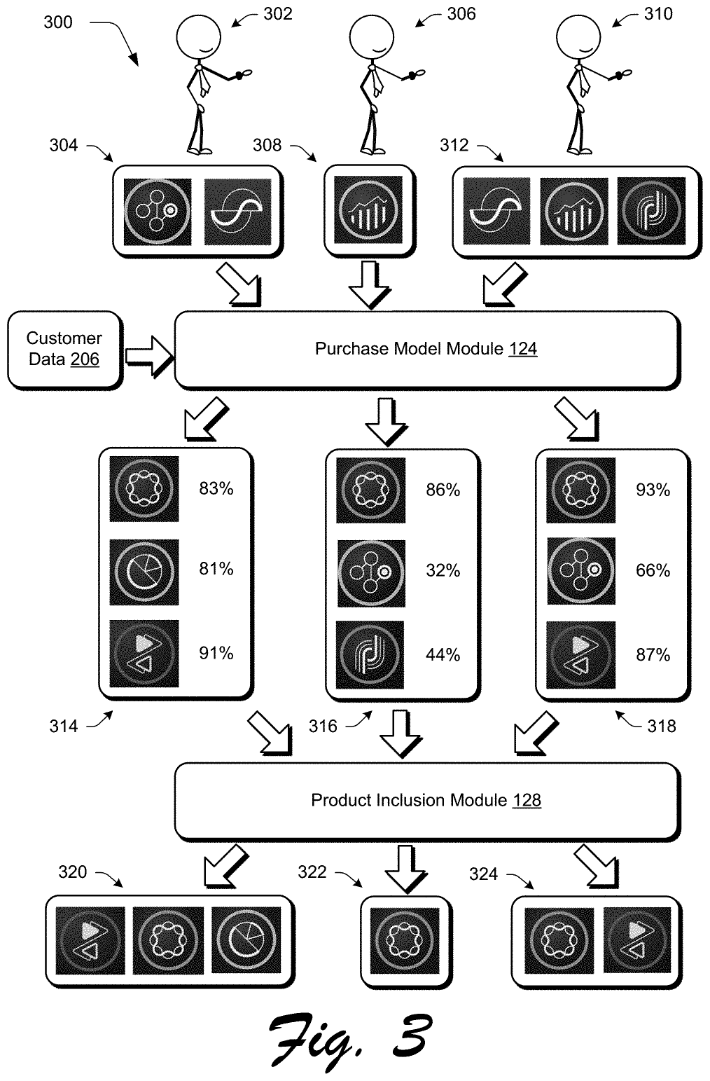

FIG. 3 depicts a system 300 in which the product prioritization techniques described herein are used to generate recommendations in scenarios involving customers having different characteristics which may be included in feature data. A first customer 302 has a purchase history 304 that includes two products, Adobe™ Target and Adobe™ Advertising Cloud. A second customer 306 has a purchase history 308 that includes one product, Adobe™ Analytics. A third customer 310 has a purchase history 312 that includes three products, Adobe™ Advertising Cloud, Adobe™ Analytics, and Adobe™ Campaign.

The purchase model module 124 receives the purchase histories 304, 308, and 312 and utilizes the purchase histories to generate a probability distribution of additional products that have not yet been purchased by the customers 302, 306, and 310. To do so, the purchase model module 124 uses customer data 206 of additional customers in a multiclass classification. For example, the purchase model module 124 may compare customers having similar respective sizes to the customers 302, 306, and 310, revenues, industries, locations, numbers of clients, status and/or structure, performance, and so forth, while foregoing comparisons to customers with different characteristics or features despite having similar purchase histories.

In this example, the purchase model module 124 sets the probability of products that the customers 302, 306, 310 have respectively previously purchased to zero. For products that the customers 302, 306, 310 have not previously purchased, the purchase model module 124 generates probability distributions 314, 316, 318 indicating the likelihood of the respective customers to purchase the products. The probability distributions 314, 316, 318 each only depict three of the additional products not yet purchased by the respective customers for clarity, but any number of additional products may be included in the probability distributions.

A first of the probability distributions 314 corresponding to the first customer 302 shows that the first customer has an 83% likelihood to purchase Adobe™ Experience Manager, an 81% likelihood to purchase Adobe™ Audience Manager, and a 91% likelihood to purchase Adobe™ Primetime. The product inclusion module 128 averages these probabilities, and determines an average of 85%. In this example, consider that the threshold value for inclusion of three products in a product recommendation is greater than or equal to 85%. Consequently, the product inclusion module 128 includes all three products indicated in the probability distribution 314 in a product recommendation 320 for the first customer 302. Furthermore, the product inclusion module 128 may arrange the products included in the product recommendation 320 in order from highest probability of being purchased to lowest probability of being purchased for efficient comprehension by a user when the recommendation is output in a user interface.

A second of the probability distributions 316 corresponding to the second customer 306 shows that the second customer has an 86% likelihood to purchase Adobe™ Experience Manager, a 32% likelihood to purchase Adobe™ Target, and a 44% likelihood to purchase Adobe™ Campaign. Again, the product inclusion module 128 averages these probabilities, and determines an average of 54%. Consider that the threshold value for inclusion of one product in this example is greater than or equal to 50%. The product inclusion module 128 then includes only the top product, Adobe™ Experience Manager, in a product recommendation 322 for the second customer 306. By excluding the two products with the lowest probabilities of being purchased, Adobe™ Target and Adobe™ Campaign, the product inclusion module 128 directs sales and marketing teams to appropriately allocate resources to the product that is most likely to be sold to the second customer 306.

A third of the probability distributions 318 corresponding to the third customer 310 depicts that the third customer has a 93% likelihood to purchase Adobe™ Experience Manager, a 66% likelihood to purchase Adobe™ Target, and an 87% likelihood to purchase Adobe™ Primetime. The product inclusion module 128 averages these probabilities to determine an average probability of 82%. In this example, the threshold value for inclusion of two products is greater than or equal to 80%. Therefore, the product inclusion module 128 includes the top two products, Adobe™ Experience Manager and Adobe™ Primetime in a product recommendation 324. By excluding the product with the lowest probability of being purchased, Adobe™ Target, the product inclusion module 128 directs sales and marketing teams to appropriately allocate resources to the products that are most likely to be sold to the third customer 310.

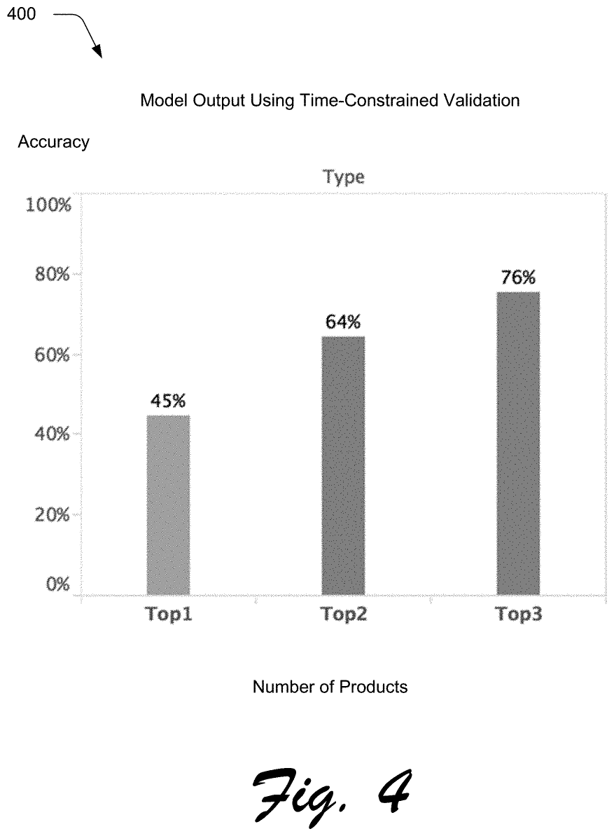

FIGS. 4-6 depict a variety of validation plots for the product prioritization techniques and systems described herein. First looking at FIG. 4, a validation plot 400 is depicted using time-constrained validation. The validation plot 400 depicts number of top products recommended in a product recommendation versus prediction accuracy. Using the Top1 product recommendation as an example, the actual product purchase outcomes are compared with the Top1 predicted product among all customers that have at least one product purchase during a year timeframe. As long as the Top1 prediction for a particular customer falls into a set of products purchased during the year timeframe, the prediction is considered a success; otherwise, the prediction is considered as a failure for the purposes of the validation plot 400. The Top1 prediction accuracy in this example is 45%.

Looking at the Top2 product recommendation, the actual product purchase outcomes are compared with the Top2 predicted products among all customers that have at least two product purchases during the year timeframe. As long as there is intersection between the two top products in the Top2 prediction and the one or more products purchased by the particular customer, the prediction a success; otherwise, the prediction is considered as a failure for the purposes of the validation plot 400. The Top2 prediction accuracy in this example is 64%. Similarly, for the Top3 product recommendation, as long as there is intersection between the three top products in the Top3 prediction and the one or more products purchased by the particular customer, the prediction a success; otherwise, the prediction is considered as a failure for the purposes of the validation plot 400. The Top3 prediction accuracy in this example is 76%.

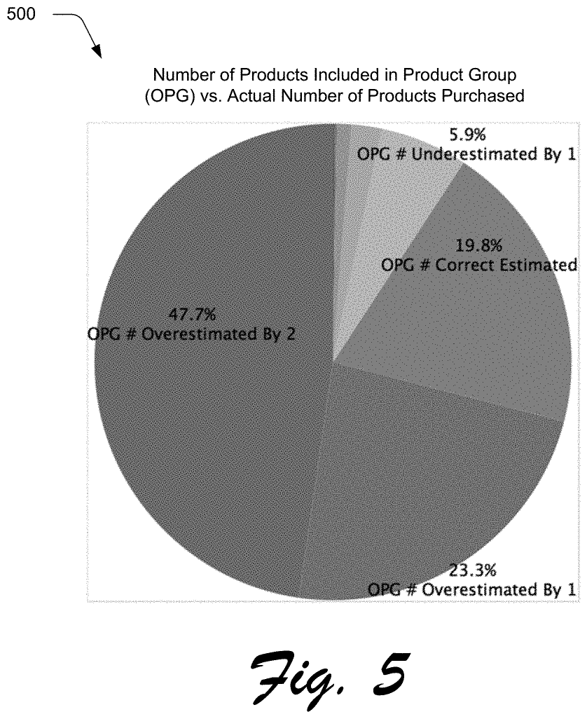

FIG. 5 depicts a validation plot 500 comparing number of products included in a product group to actual number of products purchased. For each customer evaluated, a number is derived of products included from the propensity models 130 and the inclusion criteria, such as the threshold value for inclusion in the product group. The number of products included in the product group (OPG) is compared to an actual number of products purchased by a particular customer during a given timeframe, such as one year. The labels of each section of the validation plot 500 indicate the difference between inclusion count and the actual number of products purchased, along with the percentage of customers falling into each group.

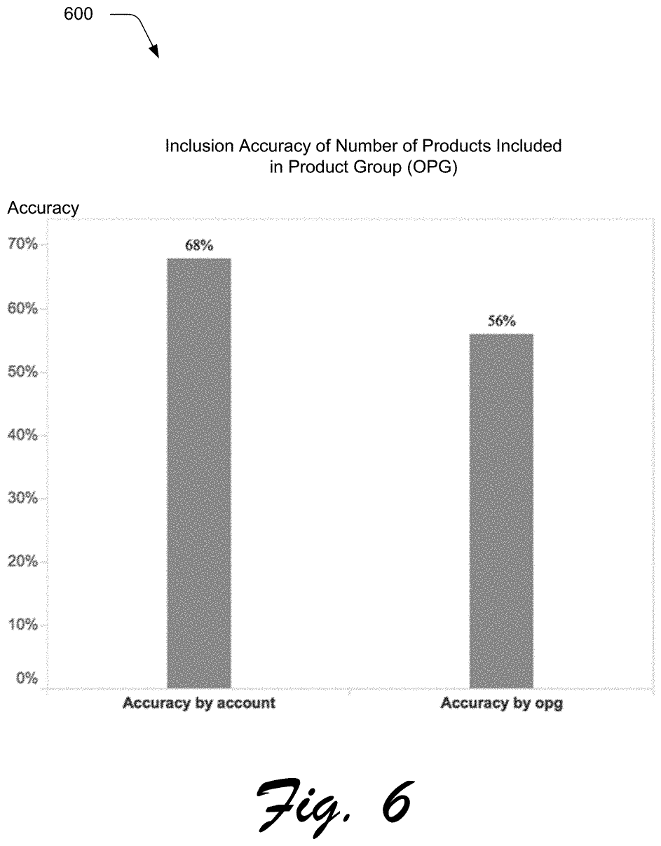

FIG. 6 is a third validation plot 600 in which inclusion accuracy of number of products included in a product group is depicted. The first bar, labeled “Accuracy by account,” is based on number of customers and is derived by dividing number of successful predictions by the number of customers having at least one purchase during a given timeframe, such as one year. The number of successful predictions is determined by intersection between the products with an inclusion label being “true” and an actual purchase by the customer.

The second bar, labeled “Accuracy by OPG,” is based on number of new purchases. To determine the Accuracy by OPG, the denominator is the number of all new purchases by all customers. For example, if a customer purchases two new products, both of the inclusion labels must be “true” to yield two successful predictions. The numerator is the number of successfully targeted new purchases with an inclusion label of “true.” Based on the two bars, accuracy by OPG (56%) is stricter than accuracy by account (68%).

Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6.

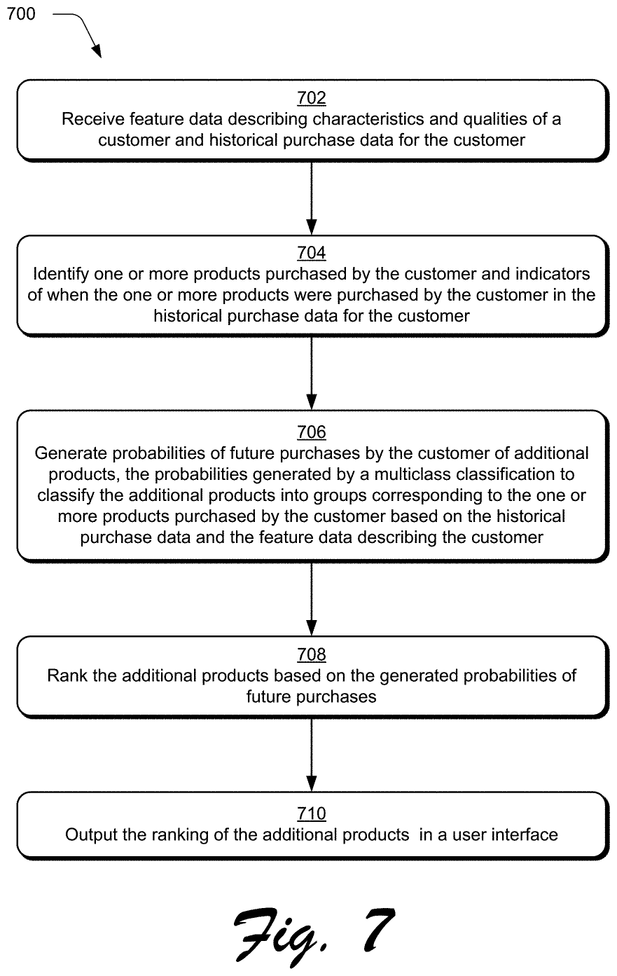

FIG. 7 depicts a procedure 700 in an example implementation in which products prioritized using a historical purchase sequence are output in a user interface by a product prioritization system. First, feature data describing a customer and historical purchase data for the customer are received, such as by the purchase model module 124 (block 702). The feature data includes descriptive attributes of the customer for use in aggregating individual customers into market segments, such as firmographic data that describes characteristics and qualities of the customer. The feature data can be used to draw comparisons between the customer and other, additional customers having similar features when using the purchase history of the customer to make predictions on additional products the customer might purchase. The purchase model module 124 identifies one or more products purchased by the customer and when the one or more products were purchased by the customer from the historical purchase data (block 704). In one example, an age or year variable is created that indicates when particular products were purchased by the customer.

The purchase model module, for instance, then generates probabilities of future purchases by the customer of additional products (block 706). To do so, a multiclass classification classifies the additional products into groups corresponding to the one or more products purchased by the customer to generate the probabilities, such as based on the historical purchase data and the feature data describing the customer. The purchase data of additional customers can be refined for use in the multiclass classification based on similarities between features of the customer and features of the additional customers as described above. The multiclass classification may be, for example, an n-class classification problem solved using a random forest model. The random forest model may then output a probability distribution representing a likelihood of the customer to purchase the additional products. In some cases, the additional products are those products not yet purchased by the customer, although examples are also contemplated in which the customer may re-purchase products and thus products already purchased may be included in the classification.

The additional products are ranked based on the generated probabilities of future purchases, such as by the ranking module 210 (block 708). The ranking indicates, for instance, which of the additional products the customer is most likely to purchase first, followed by products that the customer is less likely to purchase. As part of generating the ranking, certain ones of the additional products or services that are less likely to be purchased by the customer may be excluded from a recommendation. To do so, a propensity modeling framework (e.g., the propensity model 130 of the product inclusion module 128) can be used to determine the probability of the customer to purchase a given product. Then, the determined probabilities of the additional products may be averaged, and this average then compared to threshold values for numbers of products to include in the recommendation. The threshold values can indicate, for example, that a particular average value should result in three products included in the recommendation, that a lower average value should include two products in the recommendation, and an even lower average value should include a single product in the recommendation.

The ranking of the additional products is then output in a user interface (block 710). The ranking of the additional products may be refined using the average probability comparison to threshold values as described above. When output in the user interface, the refined number of products may be ranked in order of likelihood that the customer will purchase the additional products, while excluding products that are less likely to be purchased by the customer. Alternatively or additionally, digital content may be output in the user interface based on the ranking, such as an advertisement directly to the potential or existing customer for one or more of the additional products. In this way, users can easily and quantitatively identify products and services to target to customers that have a high probability of being purchased, without the uncertainty present in conventional systems that did not account for features of customers along with historical purchase sequence. Furthermore, sales and marketing teams can effectively allocate resources to a specific number of products that are likely to be purchased by a customer, without the waste associated with targeting products that are unlikely to be sold or omitting products that are likely to sell on an individual-customer basis.

Example System and Device

FIG. 8 illustrates an example system generally at 800 that includes an example computing device 802 that is representative of one or more computing systems and/or devices that may implement the various techniques described herein. This is illustrated through inclusion of the purchase model module 124. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium product prioritization environment, a method implemented by at least one computing device, the method comprising:
receiving, by the at least one computing device:
feature data describing characteristics and qualities of a customer; and
historical purchase data for the customer;
identifying, by the at least one computing device, one or more products purchased by the customer and indicators of when the one or more products were purchased by the customer in the historical purchase data for the customer;
generating, by the at least one computing device, probabilities of future purchases by the customer of additional products, the probabilities generated by a multiclass classification to classify the additional products into groups corresponding to the one or more products purchased by the customer based on the historical purchase data and the feature data describing the customer;
ranking, by the at least one computing device, the additional products based on the determined probabilities of future purchases; and
outputting, by the at least one computing device, digital content based on the ranking of the additional products in a user interface.

2. The method of claim 1, wherein the feature data includes descriptive attributes of the characteristics and the qualities of the customer.

3. The method of claim 2, wherein the generating the probabilities of future purchases by the customer further comprises comparing the feature data to feature data of additional customers having similar characteristics and qualities.

4. The method of claim 1, wherein the multiclass classification is a n-class classification problem solved with a random forest model.

5. The method of claim 4, wherein the random forest model generates the probabilities of the future purchases in a probability distribution of the additional products.

6. The method of claim 1, wherein the additional products do not include the one or more products purchased by the customer.

7. The method of claim 1, further comprising determining a subset of the additional products to include in a recommendation by comparing an average of the determined probabilities to a threshold probability for inclusion in the recommendation.

8. The method of claim 7, wherein the outputting further comprises outputting the recommendation including the subset of the additional products in the user interface.

9. In a digital medium product prioritization environment, a recommendation system comprising:
a purchase model module implemented at least partially in hardware of at least one computing device to determine probabilities of future purchases of products by a customer, the probabilities determined by a multiclass classification to classify the future purchases into groups corresponding to products previously purchased by the customer, the classification based on:
historical purchase data of the customer indicating the products previously purchased by the customer and when the products previously purchased by the customer were purchased; and
feature data describing characteristics and qualities of the customer; and
a product inclusion module implemented at least partially in hardware of the at least one computing device to:
generate a ranking of the future purchases based on the determined probabilities of the future purchases;
compare the determined probabilities to a threshold probability for inclusion in a product group; and
output the product group in a user interface based on the generated ranking and the comparison to the threshold.

10. The system of claim 9, wherein the feature data includes descriptive attributes of the characteristics and the qualities of the customer.

11. The system of claim 10, wherein the generating the probabilities of the future purchases by the customer further comprises comparing the feature data to feature data of additional customers having similar characteristics and qualities.

12. The system of claim 9, wherein the multiclass classification is a n-class classification problem solved with a random forest model.

13. The system of claim 9, wherein the product inclusion module is further configured to:
calculate an average of the determined probabilities; and
determine a subset of the additional products to include in the product group by comparing the average of the determined probabilities to threshold probabilities for inclusion in the product group.

14. The system of claim 13, wherein different ones of the threshold probabilities correspond to different numbers of products to be included in the product group.

15. The system of claim 9, wherein the product inclusion module is further configured to build a propensity model for each of the additional products to compare the determined probabilities.

16. In a digital medium product prioritization environment, a recommendation system comprising:
means for receiving feature data describing characteristics and qualities of a customer and historical purchase data for the customer;
means for identifying, from the historical purchase data for the customer, one or more products purchased by the customer and when the one or more products were purchased by the customer;
means for generating probabilities of future purchases by the customer of additional products, the probabilities generated by a multiclass classification to classify the additional products into groups corresponding to the one or more products purchased by the customer based on the historical purchase data and the feature data describing the customer;
means for determining a subset of the additional products to include in a recommendation by comparing an average of the determined probabilities to threshold probabilities for inclusion in the recommendation; and
means for outputting the recommendation including the determined subset of the additional products in a user interface.

17. The system of claim 16, wherein the additional products do not include the one or more products purchased by the customer.

18. The system of claim 16, wherein the additional products do include the one or more products purchased by the customer.

19. The system of claim 16, wherein different ones of the threshold probabilities correspond to different numbers of products to be included in the recommendation.

20. The system of claim 16, wherein the means for outputting the recommendation is further configured to rank the subset of the additional products included in the recommendation based on the determined probabilities.
